(19) United States
(12) Patent Application Publication
(10) Pub. No.: US 2007/0251507 A1
(43) Pub. Date: Nov. 1, 2007

(54) ADAPTATION METHOD FOR AN INJECTION SYSTEM OF AN INTERNAL COMBUSTION ENGINE

(76) Inventors: Karl Mueller, Hannover (DE); Christian Zimmer, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/697,099

(22) Filed: Apr. 5, 2007

(30) Foreign Application Priority Data
Apr. 5, 2006 (DE) 10 2006 015 967.5

(51) Int. Cl. F02M 51/00

(52) U.S. Cl. 123/493; 123/435

(57) ABSTRACT

According to an adaptation method for an injection system of an internal combustion engine, a deceleration phase of the internal combustion engine is initially detected. Within this deceleration phase the injection system activation time is varied more selectively and the combustion energy of the following combustion process is measured. On this basis a minimum injection system activation time is determined for an actually injected minimum quantity of fuel.

### RELATED APPLICATION

This application claims priority from German Patent Application No. DE 10 2006 015 967.5, which was filed on Apr. 5, 2006, and is incorporated herein by reference in its entirety.

### TECHNICAL FIELD

The present invention relates to an adaptation method for an injection system of an internal combustion engine.

### BACKGROUND

When small quantities of fuel are injected into a cylinder of the internal combustion engine with the aid of an injection nozzle or an injection system in general, it must be ensured that fuel is actually injected during the nominal minimum activation time of the injection nozzle. That is to say, it must be guaranteed that, during a single minimum activation time of the injection systems, the valve needle, for example of an injector, actually opens so that fuel enters the cylinder of the internal combustion engine.

In known methods the minimum quantity of fuel is adapted to a corresponding activation variable of the injection system in the idling and part-load mode of the internal combustion engine. For this purpose pilot injections or secondary injections are carried out in addition to the injections required in the idling and part-load mode. These pilot injections or secondary injections are activated by changing activation variables of the injection system, for example the activation time. In this operation the activation time is successively increased so that it is possible to detect a minimum activation time during which a minimum quantity of fuel is actually injected into the cylinder.

To enable the presence and size of an injected fuel quantity to be evaluated, a measurement window is defined. This measurement window is arranged according to the crankshaft angle of the internal combustion engine such that the window detects only the combustion of the adaptation injection. Combustion or the energy released during combustion is determined from the structure-borne noise signals measured inside the operating window. Structure-borne noise signals of this kind can be acquired, for example with the aid of an acceleration sensor based on the piezoelectric principle. Since combustion of the adaptation injection takes place in time proximity to the normal combustion processes of the idling and/or part-load mode, the operating window for the test injection is subject to interference from the noise of adjacent combustion processes. This noise interference distorts the evaluation of the combustion energy and thus the determination of the minimum quantity of fuel as a function of the injection system activation time.

### SUMMARY

An adaptation method for an injection system of an internal combustion engine can be provided, with which method a minimum activation variable of an injection system can be determined for a minimum injected fuel quantity with greater accuracy than in the prior art.

According to an embodiment, an adaptation method for an injection system of an internal combustion engine, may comprise the steps of detecting a deceleration phase of the internal combustion engine, activating the injection system according to a preset activation variable for the injection of a quantity of fuel into a cylinder of the internal combustion engine during the deceleration phase, and measuring a combustion energy of the injected fuel quantity, from which energy the size of the quantity of fuel can be determined, so that the preset activation variable can be assigned to a minimum injectable fuel quantity

### BRIEF DESCRIPTION OF THE DRAWINGS

The embodiments are explained in more detail with reference to the accompanying drawing. In this connection:

FIG. 1 shows a flow chart with a preferred embodiment of the present adaptation method.

### DETAILED DESCRIPTION

According to an embodiment, an adaptation method for an injection system of an internal combustion engine may have the following steps: a) detection of a deceleration phase of the internal combustion engine, b) activation of the injection system according to a preset activation variable for the injection of a quantity of fuel into a cylinder of the internal combustion engine during the deceleration phase, c) measurement of a combustion energy of the injected fuel quantity, from which energy the size of the quantity of fuel can be determined, so that the preset activation variable can be assigned to a minimum injectable fuel quantity.

By comparison with conventional methods, an embodiment of the adaptation method has the substantial advantage that the effect of interference on the determination of a minimum activation variable and of the corresponding minimum injectable fuel quantity is substantially reduced by comparison with the prior art. This is because initially there is selected a deceleration phase of the internal combustion engine in which the driver does not operate the accelerator pedal and the engine management system does not activate any injections. For this reason no further combustion of fuel quantities that could generate interference variables, especially interference noise, takes place apart from the injections and combustion processes used for the adaptation method. On this basis the structure-borne noise signals generated by the combustion of the injected fuel quantity can be evaluated more easily, so that the combustion energy or noise signal energy established therefrom enables the injection system activation variable for a minimum injectable fuel quantity to be determined with greater accuracy.

It is preferable to inject the preset quantity of fuel into the internal combustion engine cylinder and selectively to achieve the size of the quantity of fuel to be injected by modifying the injection system activation time.

According to a further alternative, an operating window in time proximity to combustion of the injected fuel quantity is defined as a function of a detected crankshaft angle of the internal combustion engine, and the combustion energy inside the operating window is established on the basis of structure-borne noise signals, preferably with the aid of an acceleration sensor.

Since the quantity of fuel injected in the course of the adaptation method is injected nominally and during the deceleration phase of the internal combustion engine, only this one combustion process takes place during the cycle of the internal combustion engine cylinder. For this reason the operating window overlapping this combustion process can be more easily positioned for the defined acquisition of the structure-borne noise signals generated by this combustion process. This is because no further combustion processes which could generate structure-borne noise signals that should not be acquired within the limits of the operating window take place in the same cylinder or in adjacent cylinders in time proximity to the aforementioned combustion process. This sequence of the adaptation method according to the above embodiment therefore enables the operating window to be positioned with higher tolerances, at the same time with enhanced accuracy of combustion energy measurement by means of the structure-borne noise signals.

According to a further embodiment, an injection cycle of the cylinder is operated without injecting a quantity of fuel, then an assumed combustion energy is measured in the following cycle of the same cylinder, and the assumed combustion energy and the combustion energy of the injected fuel quantity of a preceding injection cycle and of a corresponding combustion process are subtracted, so that the size of the injected fuel quantity can be determined from the result.

Comparative measurements are carried out in order to permit the determination of the size of a fuel quantity which is to be assigned to a specific activation variable or activation time. In the course of these comparative measurements the combustion energy is determined with the aid of structure-borne noise signals of a previously injected fuel quantity. Then the structure-borne noise signals of a cycle of the cylinder are acquired without a quantity of fuel having been previously injected and thus without combustion taking place during this cycle. The difference between these two energy values can be used to determine the size of the quantity of fuel that has been injected using the previously preset activation variable. The above subtraction makes it easy to eliminate interfering structure-borne noise signals so that only the structure-borne noise signals or energy values associated with the actual combustion of the injected fuel quantity are analyzed.

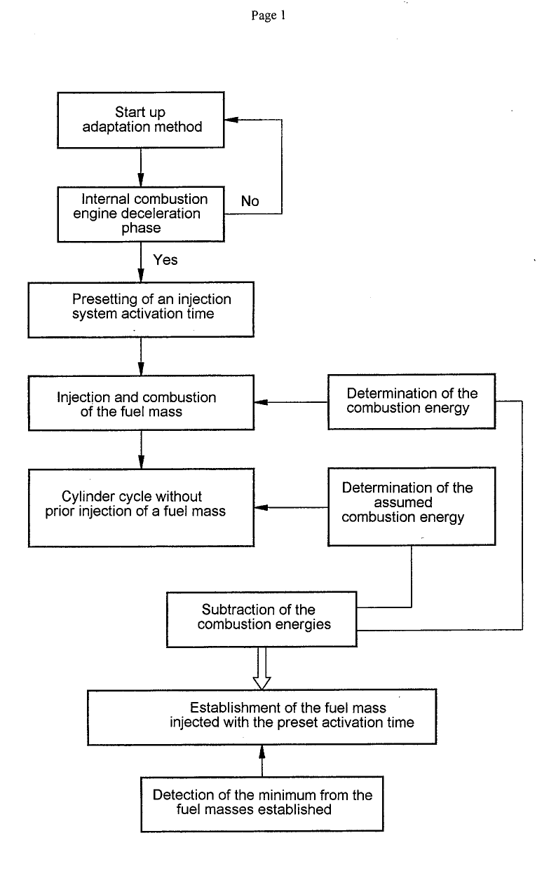

A flow chart of a preferred embodiment is shown in FIG. 1 as an example of the content and sequence of the adaptation method.

The adaptation method is controlled with the aid of the internal combustion engine management system. A separate control unit can likewise conceivably be provided for the adaptation method. The adaptation method ensures that, with a minimum activation variable of the internal combustion engine, for example an activation time or activation voltage, fuel is actually injected into the relevant cylinder of the internal combustion engine or into the cylinder that is to be adapted. To avoid interference affecting the adaptation method in the pursuit of this objective, the method is carried out in a deceleration phase of the internal combustion engine. In the deceleration phase of the internal combustion engine no torque is required by a motor vehicle driver using the accelerator pedal. Furthermore, no injection of fuel is required by the engine management system, as would, for example, be the case in an idling phase of the internal combustion engine. Thus the deceleration phase of the internal combustion engine describes a period of time and an operating mode in which normally no quantities of fuel are injected into the internal combustion engine cylinders.

If, after the adaptation method is started S1, a deceleration phase S2 is detected, the adaptation method is continued. Otherwise the adaptation method is halted and there is a wait until a deceleration phase is detected so that the adaptation method can continue.

As already mentioned above, normally no injections take place within the detected deceleration phase. This is monitored, for example, by an advanced diagnostics concept in the engine management system which prevents incorrect and undesired injections of fuel quantities. According to one embodiment, the advanced diagnostics concept clears the injections to be carried out by the adaptation method so that the advanced diagnostics concept and the adaptation method do not impede each other. According to a further embodiment, a monitoring function which is separate from the advanced diagnostics concept is used to monitor this special operation of the injection system and the internal combustion engine. In addition to the advanced diagnostics concept, it is also conceivable to carry out a plausibility check to check whether an injection taking place is for very small quantities as part of the adaptation method or whether the internal combustion engine injection system is malfunctioning. Depending on the outcome of the plausibility check, the adaptation method is continued or, if a malfunction is established, the method is interrupted accordingly.

As the adaptation method continues, there is applied an injection strategy in which, in a first injection cycle, an injection system activation time is preset for the injection of a quantity of fuel (S3) and corresponding injection and ignition take place (S4). No activation time is preset for the following injection cycle of the same cylinder of the internal combustion engine, so that no quantity of fuel is injected and therefore no combustion takes place in the following cycle (step S5). The two cycles of the same cylinder with and without combustion, which cycles are successive by virtue of the above adaptation method, are used to establish the size of the injected fuel quantity later.

During each cycle in step S6 and S7 the energy converted through the combustion process is determined and is thereafter designated combustion energy. For the cycle preceded by activation of an injection system activation time, the amount of energy is designated “combustion energy of the injected fuel quantity” (S6). For the cycle without activation of an injection system activation time, the amount of energy is designated “assumed combustion energy” (S7).

To determine the combustion energy of the cycle to be evaluated the structure-borne noise signals are acquired, for example with the aid of a piezoelectric acceleration or knock sensor. The acquisition of the structure-borne noise signals preferably does not extend over the whole of the cycle. The acquisition is carried out in a specific operating window. The operating window is arranged according to a detected crankshaft angle of the internal combustion engine and the size of the window is designed such that the combustion of the fuel quantity injected for the adaptation method can be detected. Since no combustion processes take place in the adjacent cylinders of the internal combustion engine during the cycle of the cylinder tested, there is also an absence of noise signals of combustion processes to interfere with the determination of the combustion energy in the cylinder to be adapted.

After the combustion energy of the injected fuel quantity and the assumed combustion energy have been measured from the structure-borne noise signals, these energies are subtracted from each other (S8). If the difference exceeds an optionally definable threshold value, this initially indicates that a quantity of fuel has been injected into the cylinder on the basis of the preset activation time. Furthermore, from the difference or energy analysis it is possible to calculate the size of an injected fuel quantity as a function of the preset activation time. The formation of the above difference initially enables the effects of interference noise in the detected cycles to be eliminated. In step S9 the injected fuel quantity or fuel mass is then inferred from the energy differential.

The activation time is increased stepwise from injection cycle to injection cycle in order to establish a minimum activation time for a minimum injected fuel quantity. Then, in each case according to the above description, the combustion energy is evaluated and the injected fuel quantity determined. In step S10 the minimum fuel quantity can be established from the quantities of fuel determined so that, on this basis, it is possible to preset a minimum activation time during which a minimum quantity of fuel is actually injected into the cylinder.

The above adaptation method can therefore be used to determine a nominal minimum activation time for the internal combustion engine injection system during which a minimum quantity of fuel is actually injected into the cylinder of the internal combustion engine.

What is claimed is:

1. An adaptation method for an injection system of an internal combustion engine, comprising:
a) detecting a deceleration phase of the internal combustion engine,
b) activating the injection system according to a preset activation variable for the injection of a quantity of fuel into a cylinder of the internal combustion engine during the deceleration phase,
c) measuring a combustion energy of the injected fuel quantity, from which energy the size of the quantity of fuel can be determined, so that the preset activation variable can be assigned to a minimum injectable fuel quantity.

2. The adaptation method according to claim 1, further comprising:
presetting of the quantity of fuel as a nominal fuel quantity and selective adaptation of its size by modifying an injection system activation time.

3. The adaptation method according to claim 1, further comprising:
defining an operating window in time proximity to combustion of the injected fuel quantity as a function of a detected crankshaft angle of the internal combustion engine, and
establishing the combustion energy inside the operating window on the basis of structure-borne noise signals.

4. The adaptation method according to claim 1, further comprising:
operating an injection cycle of the cylinder without injecting a quantity of fuel and measuring an assumed combustion energy in the following cylinder cycle, and
subtracting the assumed combustion energy and the combustion energy of the injected fuel quantity, so that the size of the injected fuel quantity can be determined from the result.

5. The motor control device according to claim 3, wherein the combustion energy inside the operating window is established with the aid of an acceleration sensor.

6. A motor control device for an injection system of an internal combustion engine, wherein the motor control device is operable to detect a deceleration phase of the internal combustion engine, and wherein the motor control device is further operable to activate the injection system according to a preset activation variable for the injection of a quantity of fuel into a cylinder of the internal combustion engine during the deceleration phase, and to measure a combustion energy of the injected fuel quantity, from which energy the size of the quantity of fuel can be determined, so that the preset activation variable can be assigned to a minimum injectable fuel quantity.

7. The motor control device according to claim 6, wherein the motor control device is further operable to preset the quantity of fuel as a nominal fuel quantity and selective adaptation of its size by modifying an injection system activation time.

8. The motor control device according to claim 6, wherein the motor control device is further operable to define an operating window in time proximity to combustion of the injected fuel quantity as a function of a detected crankshaft angle of the internal combustion engine, and to establish the combustion energy inside the operating window on the basis of structure-borne noise signals.

9. The motor control device according to claim 8, comprising an acceleration sensor for determining the combustion energy inside the operating window.

10. The motor control device according to claim 6, wherein the motor control device is further operable to operate an injection cycle of the cylinder without injecting a quantity of fuel and to measure an assumed combustion energy in the following cylinder cycle, and to subtract the assumed combustion energy and the combustion energy of the injected fuel quantity, so that the size of the injected fuel quantity can be determined from the result.

11. An adaptation method for an injection system of an internal combustion engine, comprising:
presetting a quantity of fuel as a nominal fuel quantity,
detecting a deceleration phase of the internal combustion engine,
activating the injection system according to a preset activation variable for the injection of a quantity of fuel into a cylinder of the internal combustion engine during the deceleration phase,
measuring a combustion energy of the injected fuel quantity, from which energy the size of the quantity of fuel can be determined, so that the preset activation variable can be assigned to a minimum injectable fuel quantity,
selectively adapting the quantity of fuel by modifying an injection system activation time.

12. The adaptation method according to claim 11, further comprising:
defining an operating window in time proximity to combustion of the injected fuel quantity as a function of a detected crankshaft angle of the internal combustion engine, and
establishing the combustion energy inside the operating window on the basis of structure-borne noise signals.

13. The adaptation method according to claim 11, further comprising:
operating an injection cycle of the cylinder without injecting a quantity of fuel and measuring an assumed combustion energy in the following cylinder cycle, and
subtracting the assumed combustion energy and the combustion energy of the injected fuel quantity, so that the size of the injected fuel quantity can be determined from the result.

14. The motor control device according to claim 12, wherein the combustion energy inside the operating window is established with the aid of an acceleration sensor.
